(19) United States
(12) Patent Application Publication
(10) Pub. No.: US 2004/0104883 A1
(43) Pub. Date: Jun. 3, 2004

(54) Method and apparatus for adjusting the color saturation in a transreflective display

(76) Inventor: Marc A. Drader, Waterloo (CA)

Correspondence Address: David B. Cochran, Esq., JONES DAY, North Point, 901 Lakeside Ave, Cleveland, OH, 44114, US

(21) Appl. No.: 10/366,090

(22) Filed: Feb. 12, 2003

Related U.S. Application Data
(60) Provisional application No. 60/430,371, filed on Dec. 3, 2002.

(30) Foreign Application Priority Data
Nov. 29, 2002 (CA) 2,413,333

(51) Int. Cl. G09G 3/36

(52) U.S. Cl. 345/102

(57) ABSTRACT

A method for adjusting a gamma setting of a display for a mobile device is disclosed. The display has two brightness settings, where the two brightness settings include a transmissive mode setting and a reflective mode setting. The method includes: a) changing the display to a selected brightness setting; and b) changing the gamma setting of the display to a predetermined gamma setting corresponding to the selected brightness setting. The predetermined gamma setting optimizes an image on the display at the selected brightness setting. The method also includes switching a back light connected to the display, where the back light is switched to the on position in the transmissive setting and to the off position in the reflective setting.

### CROSS-REFERENCE TO RELATED APPLICATIONS

This application claims priority from Canadian Patent Application No. 2,413,333, filed on Nov. 29, 2002, and also claims the benefit of U.S. Provisional Application No. 60/430,371, filed on Dec. 3, 2002.

### FIELD OF THE INVENTION

The invention relates to display devices, and in particular, to display devices having a transmissive mode and a reflective mode (also known as “transreflective” or “transflective” displays).

### BACKGROUND OF THE INVENTION

Transreflective displays are popular choices for consumer electronic devices, such as wireless phones, personal digital assistants (PDAs), and other mobile devices. Currently, available transreflective displays are liquid crystal displays (LCDs). Transreflective displays operate in two modes. One of the modes is a transmissive mode, where a source of illumination is placed behind the LCD layers to facilitate visualization of the resultant image. The other mode is a reflective mode where there is no illumination behind the LCD layers such that the viewer relies on the ambient light reflecting from the LCD to view the display. The reflective mode is especially helpful with LCDs for mobile devices, which have battery power limitations. By operating the display of the mobile device in the transmissive mode only when ambient light is insufficient for clear viewing, the battery life of a mobile device is extended.

However, changing between the transmissive and reflective modes has an effect on the appearance of the color quality or saturation displayed on the LCD screen. This color saturation may be adjusted by changing the gamma setting of the display.

Display devices, such as LCDs, display image colors in a linear fashion (with some amount of distortion), where one unit of input produces one unit of output. In contrast, human eyes see images logarithmically. The linear optical response of LCDs at the lower and higher ends of output (also referred to as “digital bit value”) changes too quickly for the human eye, causing some compression of the shadow detail where human eyes are very sensitive. Accordingly, instead of a linear response, the output of LCDs is adjusted from a linear setting to an exponential curve, referred to in the art as a “gamma curve”. The gamma curve, has a long and gradually curved beginning and end portions, and a substantially flat steeper middle portion. The gamma curve or setting is based on a polynomial equation describing any point on a brightness curve being output by a particular display. Its function is to correct for the non-linearity of the input signal and its corresponding luminance.

The purpose of adjusting the output of displays in accordance with a gamma curve is to match the output of the display to the characteristics of the human eye (i.e. the increased sensitivity of the human eye at the lower and higher ends of output).

Each of the display modes (i.e. the transmissive and reflective modes) has its own optimal gamma setting. If the gamma setting of the display is optimized for the reflective mode, colors may appear “washed out” in the transmissive mode. On the other hand, if the gamma setting is optimized for the transmissive mode, the colors may appear over-saturated or dark. This occurs because, in the reflective mode, light passes twice through the color filters in the LCD. Light passes through the color filters once from the ambient light source through the LCD to the reflector, and a second time from the reflector to the viewer's eye. In the transmissive mode, the light originates at a light source behind the LCD, and passes through the LCD once on its way to the viewer's eye.

Accordingly, there is a need for a method and an apparatus for optimizing the image on a transreflective display by changing the gamma setting of the display.

### SUMMARY OF THE INVENTION

According to a first aspect of the invention, a method for adjusting a gamma setting of a display having a plurality of brightness settings is provided. The method comprises: (a) changing the display to a selected brightness setting, wherein the selected brightness setting is one of the plurality of brightness settings; and b) changing the gamma setting of the display to a predetermined gamma setting corresponding to the selected brightness setting, the predetermined gamma setting being adapted to optimize an image on the display.

According to a second aspect of the invention, a computer readable medium, including a computer program that adjusts a gamma setting for a display having a plurality of brightness settings, is provided. The computer program causes the computer to perform the steps of:

a) changing the display to a selected brightness setting, wherein the selected brightness setting is one of the plurality of brightness settings; and

b) changing the gamma setting of the display to a predetermined gamma setting corresponding to the selected brightness setting, the predetermined gamma setting being adapted to optimize an image on the display.

According to a third aspect of the invention, an apparatus for adjusting a gamma setting of a display having a plurality of brightness settings is provided. The apparatus comprises:

a) a means for changing the display to a selected brightness setting, wherein the selected brightness setting is one of the plurality of brightness settings; and

b) a means for changing the gamma setting of the display to a predetermined gamma setting corresponding to the selected brightness setting, the predetermined gamma setting being adapted to optimize an image on the display.

### BRIEF DESCRIPTION OF THE DRAWINGS

The present invention will now be described by way of example only with reference to the accompanying drawings, in which:

FIG. 1 is a block diagram of an apparatus according to the preferred embodiment of the invention; and

FIG. 2 is a chart showing two gamma settings for the apparatus shown in FIG. 1.

### DETAILED DESCRIPTION OF THE INVENTION

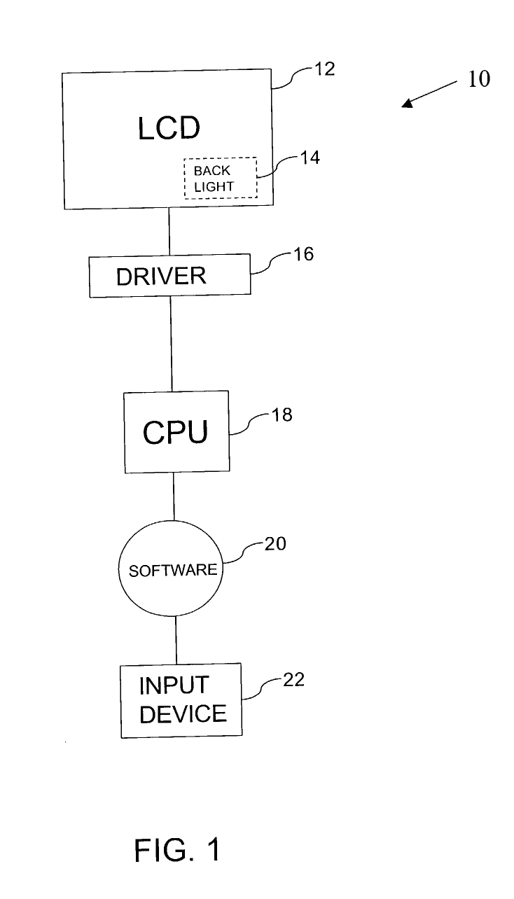

FIG. 1 shows an apparatus according to the preferred embodiment of the invention. Preferably, the apparatus is a mobile computing device 10, but may be any other suitable device having a transreflective display 12. The display 12 includes a back light 14 to control the illumination of the display 12. When the back light 14 is on, the display 12 is in a transmissive mode, and when it is off, the display 12 is in a reflective mode. Preferably, the display 12 is a color LCD screen.

In an alternative embodiment the back light 14 may have several illumination levels to provide several transmissive modes.

Referring to FIG. 1, the display 12 is in communication with a driver 16. The driver is in communication with a central processing unit (CPU) 18 of the mobile computing device 10. The CPU 18 sends commands to the driver 16 which controls the images appearing on the display 12, as well as other characteristics of the display 12, as is well known in the art. In particular, the CPU 18 sends commands to the driver 16 to turn the back light 14 on and off, and to change the gamma setting on the display 12.

In an alternative embodiment where the back light 14 has several illumination levels, the driver 16 switches the illumination levels of the back light 14 in response to commands received from the CPU 18.

Continuing to refer to FIG. 1, the CPU 18 is in communication with software 20 which communicates with the hardware components of the mobile computing device 10. Depending on the type of mobile device, the software may be an operating system, a Java Virtual Machine, Java applications, or any other suitable software, as is well known in the art. The software 20 receives a signal indicating a selected brightness setting for the display 12 from an input device 22 and translates the signal to a command to the CPU 18. Any suitable number of brightness settings may be provided in the mobile computing device 10 to correspond to varying levels of ambient light.

The user of the mobile computing device 10 may change the brightness setting of the display 12 preferably in response to variation in the ambient light. The user chooses the selected brightness setting by actuating the input device 22. The input device 22 may be a button or buttons on the device, a touch screen, or any other suitable device.

Alternatively, the input device 22 may be a light sensor which detects the level of ambient light and sends this information to the software 20. The software 20 may then select the optimal brightness setting for the ambient light and communicate the selected brightness setting to the CPU 18, as is well known in the art. The selection algorithm may be programmed into the software in any number of known ways.

The operation of the method according to a preferred embodiment of the present invention will now be described with reference to FIG. 1.

The user of the mobile computing device 10 may choose the brightness setting for the display 12 using the input device 22. Alternatively, a light sensor (not shown) may sense the level of ambient light and communicate the information to the software 20, as discussed above. The selected brightness setting may be chosen automatically by the software 20 without participation of the user, as described above.

Each brightness setting has a corresponding predetermined gamma setting. In low ambient light, the predetermined gamma setting for the selected brightness setting is preferably optimized for a transmissive mode setting where the back light 14 is on. In brighter ambient light, the predetermined gamma setting for selected brightness setting may be optimized for a reflective mode setting where the back light 14 is off.

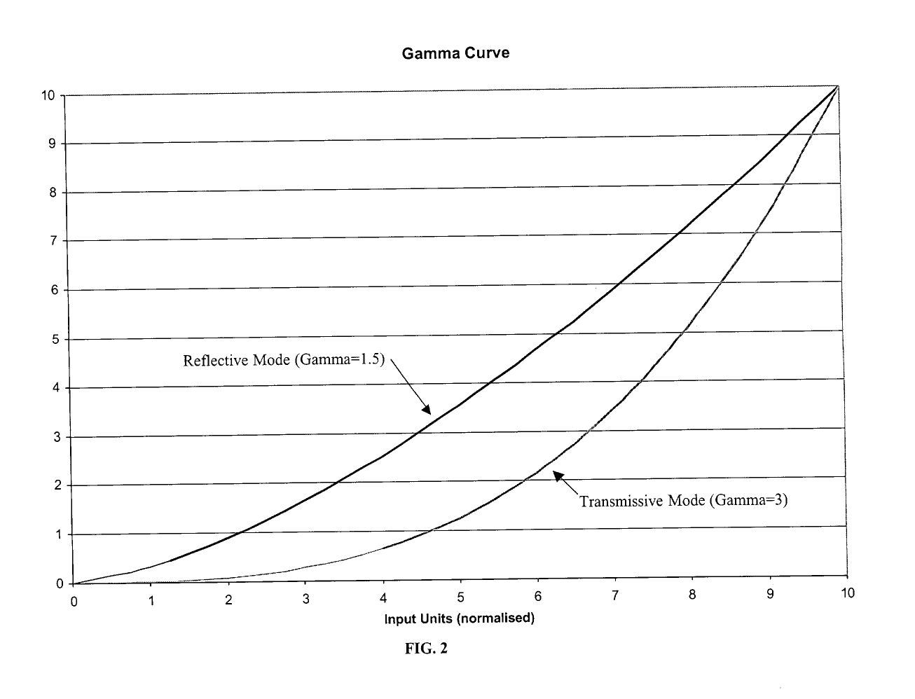

An example of a gamma setting for each of the modes is illustrated in FIG. 2. As shown in FIG. 2, the predetermined gamma setting (gama=3) for the transmissive mode is higher than the predetermined gamma setting (gamma=1.5) for the reflective mode.

In an alternative embodiment of the invention, several transmissive mode settings may be provided to optimize the display 12 for different levels of low ambient light. In such an embodiment, the back light 14 has several illumination levels, where each of the levels is a different transmissive mode setting. The back light 14 may be set for maximum brightness in the transmissive mode setting optimized for little or no ambient light, with each of the other transmissive mode settings being set to consecutively lower illumination levels from the back light 14, to match viewing conditions with greater amounts of ambient light.

In an embodiment where the input device 22 is a light sensor, several reflective mode settings may also be provided to optimize the gamma setting for different levels of ambient light where the back light 14 is not necessary for viewing. For example, one reflective mode setting may be provided for bright sunlight and another for normal light conditions.

The input device 22 sends a signal to the software 20 indicating the selected brightness setting. The software translates the signal, as is well known in the art, and forwards the command to the CPU 18. Preferably, the CPU 18 sends two simultaneous commands on a data bus (not shown) connecting the CPU 18 and driver 16 for the display 12. As used herein, “simultaneously” means any period of time which is substantially imperceptible to the viewer. However, it will be understood by those skilled in the art, that the commands do not have to be simultaneous, and that there may be a measurable delay between the change in the selected brightness setting and the change in gamma setting.

The data bus may be a 16 bit data bus. Alternatively, the connection between the CPU 18 and the driver 16 may be made serially via a series of discrete outputs (i.e. a dedicated pin that enables/disables the backlight, or sets the brightness). In another alternative embodiment, a graphics co-processor (not shown) may be provided. The graphics co-processor may take commands from the CPU 18, and interpret them for the display 12.

The first command from the CPU preferably changes the state of a register (not shown) on the driver 16 responsible for switching between the brightness levels of the back light 14. In the embodiment where there is only one transmissive and one reflective mode, the driver 16 toggles the back light 14 on and off. The second command from the CPU 18 writes to another register (not shown) on the driver 16 responsible for changing the gamma setting of the display 12 to a predetermined gamma setting corresponding to the selected brightness setting. It will be understood by those skilled in the art, that the order of the commands is not essential to the invention, particularly if the commands are executed simultaneously, as discussed above. The commands may have the order discussed above or they may be reversed. Specifically, the gamma setting of the display 12 may be adjusted prior to switching of the back light 14.

In the embodiment where more than one reflective mode setting is provided and the switch is from one reflective mode setting to another reflective mode setting, no command to the back light 14 may be necessary.

In response to the commands from the CPU 18, the driver 16 sends an electrical signal to enable the back light 14. If the command is to select one of the transmissive mode settings, the back light 14 is switched to the illumination level corresponding to the selected transmissive mode setting. If the command is to select the reflective mode setting, the back light 14 is switched to the off position, unless it was already off (i.e. in the embodiment where more than one reflective mode settings are provided). The driver 16 also changes the voltage level and characteristics to the display 12 in order to achieve a predetermined gamma setting optimal for the selected mode. Preferably, the illumination level change (if necessary) and the gamma setting change on the display 12 are carried out simultaneously. To achieve optimal display appearance for the user, the gamma setting increases with the illumination level of the back light, such that the gamma is higher in the transmissive modes and lower in the reflective mode (as shown in FIG. 2). The exact gamma setting for providing optimal color saturation in each mode varies widely with each device and the effect desired by the manufacturer.

In order to create a more smooth transition in the color saturation during a display mode change, the gamma setting may be adjusted gradually. As used herein, “gradually” is any period of time in which the user will not notice the change in color saturation (i.e. gamma setting) of the display 12. Preferably, the gradual adjustment is made by dividing the required adjustments into a series of partial adjustments carried out over a suitable period of time. The gamma setting change in each partial adjustment is imperceptible to the user. Depending, on the severity of the required adjustment, the time to make the required adjustment is extended so that it is imperceptible to the user. For example, the period of time for an adjustment may be one second, with each step being implemented in milliseconds.

The gradually shifting gamma setting may be used in conjunction with a backlight that tends to “warm up” or change illumination level gradually (e.g. a backlight which utilizes EL (electro luminescent) panels).

In an alternative device configuration (not shown), the back light 14 may be a separate hardware component from the display 12. In this case, the back light 14 is not controlled by the driver 16, but may be controlled directly by the CPU 18.

The method according to the present invention improves the picture on the display 12 by optimizing the gamma setting for different ambient light conditions.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method for adjusting a gamma setting of a display having a plurality of brightness settings, the method comprising:
a) changing the display to a selected brightness setting, wherein the selected brightness setting is one of the plurality of brightness settings; and
b) changing the gamma setting of the display to a predetermined gamma setting corresponding to the selected brightness setting, the predetermined gamma setting being adapted to optimize an image on the display.

2. The method of claim 1, wherein step (a) further comprises switching a back light between an on position and an off position, wherein the plurality of brightness settings comprise a reflective mode setting where the back light is switched to the off position setting and a transmissive mode setting where the back light is switched to the on position.

3. The method of claim 2, wherein the display is an LCD.

4. The method of claim 3, wherein steps (a) and (b) occur simultaneously.

5. The method of claim 2, wherein step (b) further comprises gradually changing the gamma setting to the predetermined gamma setting for the selected brightness setting.

6. The method of claim 3, wherein step (a) further comprises choosing the selected brightness setting.

7. The method of claim 6, wherein choosing the selected brightness setting comprises actuating an input device.

8. The method of claim 7, wherein the input device is actuated by a user.

9. The method of claim 7, wherein step (b) further comprises writing to a register on a driver for the display, wherein the register is adapted to control the gamma setting for the display.

10. The method of claim 1, wherein the plurality of brightness settings comprise a plurality of reflective mode settings and a plurality of transmissive mode settings.

11. The method of claim 10, wherein step (a) further comprises switching a back light operatively connected to the display between an off position and a plurality of on positions, wherein each of the on positions corresponds to one of the plurality of transmissive mode settings.

12. The method of claim 11, wherein the back light is in the off position in each of the plurality of the reflective mode settings.

13. The method of claim 12, wherein step (a) further comprises a driver switching the back light between the on and off positions.

14. The method of claim 13, wherein step (a) further comprises a CPU switching the back light between the on and off positions.

15. The method of claim 14, wherein prior to step (a), the method further comprises:
i) detecting a variation in ambient light; and
ii) selecting one of the plurality of brightness settings adapted to optimize viewing of the display for the ambient light.

16. The method of claim 1, further comprising switching a back light between an on position and an off position, wherein the plurality of brightness settings comprise a reflective mode setting where the back light is switched to the off position setting and a transmissive mode setting where the back light is switched to the on position.

17. A computer readable medium including a computer program that adjusts a gamma setting for a display having a plurality of brightness settings, the computer program causing the computer to perform the steps of:
a) changing the display to a selected brightness setting, wherein the selected brightness setting is one of the plurality of brightness settings; and
b) changing the gamma setting of the display to a predetermined gamma setting corresponding to the selected brightness setting, the predetermined gamma setting being adapted to optimize an image on the display.

18. An apparatus for adjusting a gamma setting of a display having a plurality of brightness settings, the apparatus comprising:
a) a means for changing the display to a selected brightness setting, wherein the selected brightness setting is one of the plurality of brightness settings; and
b) a means for changing the gamma setting of the display to a predetermined gamma setting corresponding to the selected brightness setting, the predetermined gamma setting being adapted to optimize an image on the display.
